(19) United States
(12) Patent Application Publication
(10) Pub. No.: US 2020/0005278 A1
(43) Pub. Date: Jan. 2, 2020

(54) SYSTEMS AND METHODS FOR LINKING ACCOUNTS USING AN ENABLEMENT TOKEN

(71) Applicant: JPMorgan Chase Bank, N.A., New York, NY (US)

(72) Inventors: Raghuram Vudathu, Downington, PA (US); Reetu Bok, Philadelphia, PA (US); Gayathri Sundar, Irving, TX (US)

(21) Appl. No.: 16/021,788

(22) Filed: Jun. 28, 2018

(51) Int. Cl. G06Q 20/36; G06F 9/54; H04L 29/06; G06Q 20/40

(52) U.S. Cl. CPC G06Q 20/363; G06Q 20/4014; H04L 63/0853; G06F 9/547

(57) ABSTRACT

Integrating systems using an enablement token are disclosed. According to one embodiment, in an information processing apparatus for a first provider comprising at least one computer processor, a method for linking a plurality of accounts using an enablement token, may include: (1) receiving, from a first provider user interface for the first provider and from a customer, a request for an enablement token to link a product provided by the first provider with a second provider; (2) generating the enablement token; (3) sending the enablement token to the first provider user interface; (4) receiving, from a second provider, the enablement token and a customer identifier for the customer with the second provider; (5) validating the enablement token; and (6) sending an authorization code and a product identifier for the product to the second provider.

### BACKGROUND OF THE INVENTION

### 1. Field of the Invention

The present disclosure generally relates to systems and methods for linking accounts using an enablement token.

### 2. Description of the Related Art

Customers often link their electronic wallets to merchants or payment providers. To do this, customers often have to log in to an electronic wallet, request that the electronic wallet be linked to a merchant or payment provider, log in to the merchant or payment provider's website, and log in with the electronic wallet provider for a second time. The additional log ins often result in customers abandoning the linking process, and the customers instead may simply provide payment credentials directly to the merchant.

### SUMMARY OF THE INVENTION

Systems and methods for linking accounts using an enablement token are disclosed. According to one embodiment, in an information processing apparatus for a first provider comprising at least one computer processor, a method for linking a plurality of accounts using an enablement token, may include: (1) receiving, from a first provider user interface for the first provider and from a customer, a request for an enablement token to link a product provided by the first provider with a second provider; (2) generating the enablement token; (3) sending the enablement token to the first provider user interface; (4) receiving, from a second provider, the enablement token and a customer identifier for the customer with the second provider; (5) validating the enablement token; and (6) sending an authorization code and a product identifier for the product to the second provider.

In one embodiment, the first provider user interface may include a browser tab for the first provider.

In one embodiment, the product may include an electronic wallet.

In one embodiment, the enablement token may include an alphanumeric string.

In one embodiment, the enablement token may include a token expiration field.

In one embodiment, the enablement token may include a state, and the state may include one of issued, consumed, and terminated.

In one embodiment, the customer identifier may uniquely identify the customer.

In one embodiment, the method may further include receiving, at an API gateway for the first provider, a client secret from the second provider; and the API gateway validating the client secret before validating the enablement token.

According to another embodiment, a system for linking a plurality of accounts using an enablement token may include a first provider backend comprising at least one computer processor, a first provider user interface executed by a mobile electronic device, and a second provider user interface executed by the mobile electronic device. The first provider backend may receive a request for an enablement token to link a product provided by the first provider with a second provider from the first provider user interface and from a customer, may generate the enablement token, may send he enablement token to the first provider user interface, may receive the enablement token and a customer identifier for the customer with the second provider from the second provider, may validate the enablement token, and may send an authorization code and a product identifier for the product to the second provider.

In one embodiment the first provider backend may include a first provider API gateway.

In one embodiment, the first provider user interface may include a browser tab for the first provider.

In one embodiment, the product may include an electronic wallet.

In one embodiment, the enablement token may include an alphanumeric string.

In one embodiment, the enablement token may include a token expiration field.

In one embodiment, the enablement token may include a state, and the state may include one of issued, consumed, and terminated.

In one embodiment, the customer identifier may uniquely identify the customer.

In one embodiment, the API gateway may receive a client secret from the second provider; and the API gateway may validate the client secret before validating the enablement token.

In one embodiment, the first provider user interface may provide the enablement token to the second user interface.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for linking accounts using an enablement token according to one embodiment; and

FIG. 2 depicts a method for linking accounts using an enablement token according to one embodiment.

### DETAILED DESCRIPTION OF PREFERRED EMBODIMENTS

Embodiments disclosed herein relate to integrating systems using an enablement token. For example, embodiments may enhance the industry-standard 3 legged oAuth pattern to eliminate multiple redirections and logins while keeping the same level of security. In embodiments, this may be achieved by generating a one-time, short-lived, secured token (e.g., an enablement token) that may be mapped to a specific customer and merchant combination. This token is send to a second system, which may use the enablement token to securely exchange data.

In embodiments, a enablement token may be used to link an electronic wallet to a merchant or a payment provider while minimizing additional log ins by the customer. In one embodiment, the enablement token may be generated by a backend for a first system (e.g., the electronic wallet provider) and may be send to a second system (e.g., the merchant or payment provider) across a browser session.

In embodiments, the use of the enablement token may provide improvements to the standard 3-legged OAUTH process.

The enablement token may be mapped to a customer identifier or attribute with a first provider, and a customer identifier or attribute with a second provider. In one embodiment, the enablement token may be a short lived, one-time usable token, that has no value when replayed. For example, it may have an expiration time that may set to be slightly longer than with a standard authorization code (which is 60 seconds) to give the logged in customer enough time to finish the customer activity.

In one embodiment, the enablement token cannot be replayed as it may be limited to a single use.

In one embodiment, the enablement token may be sent to the merchant or payment provider with the merchant/payment provider customer details (e.g., customer ID, customer email ID, etc.) to exchange for the oAuth standard authorization code and customer ID. The merchant/payment provider host may then use the oAuth standard authorization code and customer ID to exchange for oAuth standard access and refresh tokens, which may be required to consume resources provided by the electronic wallet provider (e.g., APIs, data, resources, etc.).

In one embodiment, the enablement token may maintain different states (e.g., issued, consumed, terminated) that will change as part of its life-cycle.

In one embodiment, the enablement token may maintain issued time stamp and expiry time stamp fields to make sure standard oAuth Grant Type (e.g., authorization code) and oAuth standard tokens (e.g., access token and refresh token) are exchanged during this time frame only.

Although this disclosure may be made in the context of an electronic wallet and a merchant or payment provider, it should be recognized that this disclosure is not so limited.

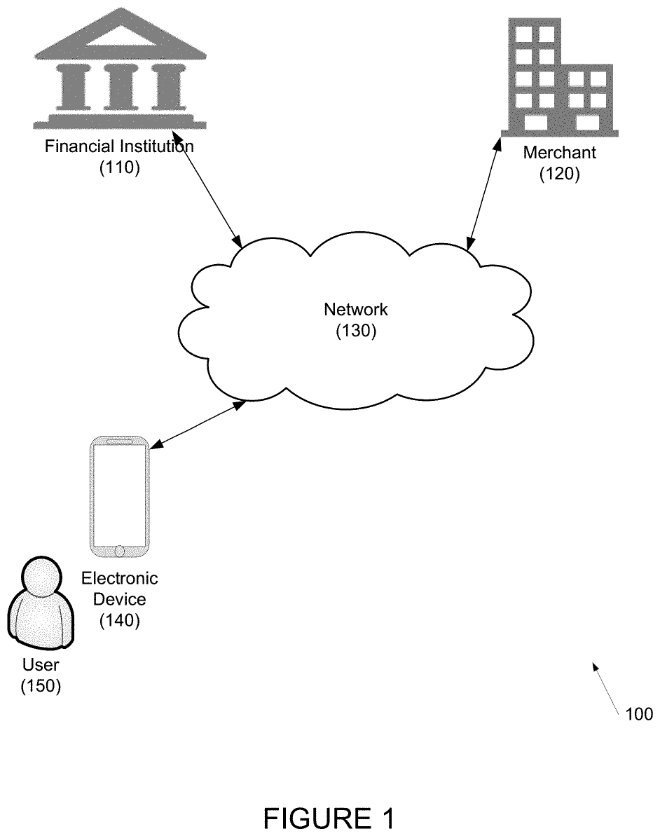

Referring to FIG. 1, a system for linking accounts using an enablement token according to one embodiment. System 100 may include financial institution 110, one or more merchants 120, network 130, and electronic device 140 that is being used by user 150. In one embodiment, electronic device 140 may be any suitable electronic device, including smartphones, tablet computers, desktop and notebook computers, Internet of Things (IoT) appliances, etc., and may execute a computer program or application provided by financial institution 110 and merchant 120.

In one embodiment, the computer program provided by financial institution 110 may be an electronic wallet application, and the computer program provided by merchant 120 may be a payment application (e.g., PayPal or similar).

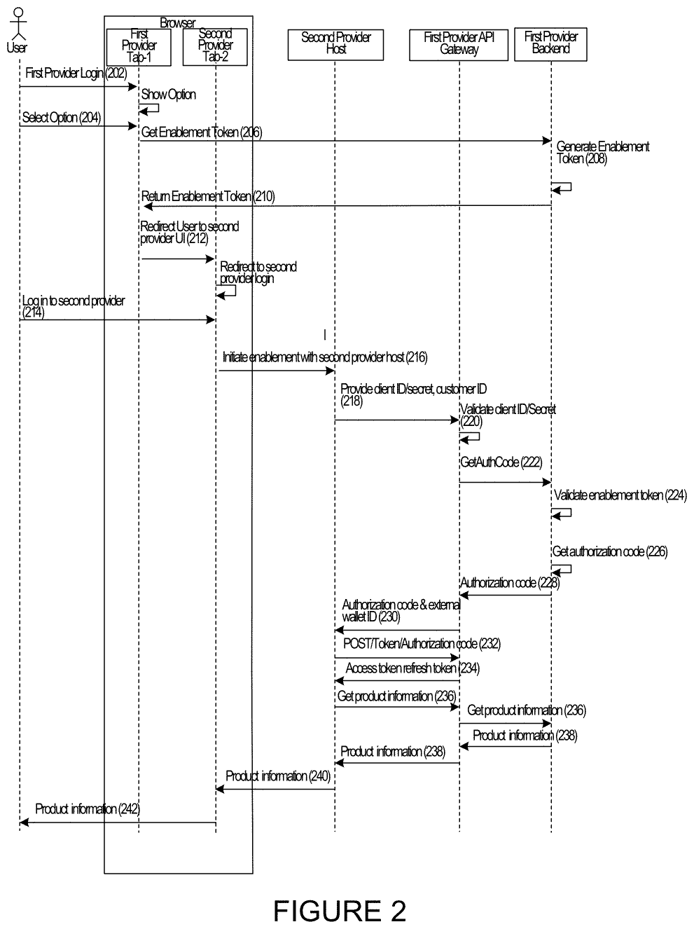

Referring to FIG. 2, a method for linking accounts using an enablement token according to one embodiment.

In step 202, a user may log in to a website hosted by a first provider (e.g., a financial institution) using a browser (e.g., either mobile based or desktop based), an application executed by a mobile device, etc. For example, the user may provide a username and password, a biometric login (e.g., touch-based, face or feature based, etc.), single sign on, etc. Other information for logging in may be provided as is necessary and/or desired. This may be used to integrate two systems in the same or different domains (e.g., mobile, desktop, native application, browser, fat client, thin clients, etc.), or hosted by the same or different providers/organizations.

In one embodiment, the login may be performed on a first tab of a browser.

In step 204, the user may request to a product provided by the first provider (e.g., an electronic wallet) linked to a second provider (e.g., a merchant, payment provider, etc.). For example, a banner may be displayed asking the customer if the customer wants to have his or her account linked to the second provider. Any suitable trigger, both manual (e.g., requiring user interaction such as a click), or automated, may be used as is necessary and/or desired.

If the customer selects the banner (e.g., by clicking on it) or link, in step 206, a backend for the first provider may generate an enablement token. For example, the website may request the enablement token from the backend.

In one embodiment, as discussed above, the enablement token may be a one-time, short-lived token. The enablement token may be a random number, an alphanumeric string, a digitally-signed string, an encrypted string, etc., and may be mapped to the first provider and the second provider.

In step 208, the first provider backend may generate the enablement token, and in step 210, may return the enablement token to the browser.

In one embodiment, the browser may sign the enablement token. For example, the browser may sign the enablement token with an encoded RSA signature, or an ECC signature, or any other suitable encryption mechanism.

In step 212, the browser may redirect the user to a second provider user interface in a second tab, and in step 214, the user may log in to the second provider using, for example, a username and password.

In step 216, the browser may initiate enablement with the second provider host, and in step 218, the second provider host may provide a client ID/secret, the enablement token, a second provider customer ID, etc. to the first provider.

In one embodiment, in step 220, an optional API gateway for the first provider may validate the client ID/client secret, and in step 222, may then communicate a request to get an authorization code to the first provider host, which may include the enablement token and a second provider identifier.

In step 224, the first provider host may validate the enablement token, and may verify that the user does not already have a first provider product linked to the second provider.

If the user already has the product linked, the user may be so informed and the process may stop.

In one embodiment, if the enablement token is signed, the first provider host may further validate that the enablement token string and the second provider customer ID exists in a database; that the enablement token has not expired; that the enablement token signature is valid, etc. To validate that the enablement token signature is valid, the first provider host may perform a database lookup of the public key corresponding to the enablement token.

In step 226, the first provider host may get an authorization code and any other customer information from the second provider that may be used to uniquely identify the customer, and, in step 228 may communicate the authorization code to the second provider host directly or via the first provider API gateway.

In step 230, the first provider or the first provider API/Gateway may provide the authorization code and an external wallet identifier to the second provider host. In step 232, the second provider host may post the token to the first provider or the first provider API/Gateway to exchange for the oAuth tokens. In step 234, the first provider or the first provider API/Gateway may provide an access token refresh token to the second provider host.

In step 236, the second provider host may get information for the product (e.g., for the electronic wallet) from the first provider host directly or via the API gateway, and in step 238, the first provider host may return the product information to the second provider host directly or via the API gateway.

In step 240, the second provider host may return the product information to the second provider user interface on the second tab. In step 242, the product information may then be displayed to the user.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for linking a plurality of accounts using an enablement token, comprising:
in an information processing apparatus for a first provider comprising at least one computer processor:
receiving, from a first provider user interface for the first provider and from a customer, a request for an enablement token to link a product provided by the first provider with a second provider;
generating the enablement token;
sending the enablement token to the first provider user interface;
receiving, from a second provider, the enablement token and a customer identifier for the customer with the second provider;
validating the enablement token; and
sending an authorization code and a product identifier for the product to the second provider.

2. The method of claim 1, wherein the first provider user interface comprises a browser tab for the first provider.

3. The method of claim 1, wherein the product comprises an electronic wallet.

4. The method of claim 1, wherein the enablement token comprises an alphanumeric string.

5. The method of claim 1, wherein the enablement token comprises a token expiration field.

6. The method of claim 1, wherein the enablement token comprises a state.

7. The method of claim 6, wherein the state is one of issued, consumed, and terminated.

8. The method of claim 1, wherein the customer identifier uniquely identifies the customer.

9. The method of claim 1, further comprising:
receiving, at an API gateway for the first provider, a client secret from the second provider; and
the API gateway validating the client secret before validating the enablement token.

10. A system for linking a plurality of accounts using an enablement token, comprising:
a first provider backend comprising at least one computer processor;
a first provider user interface executed by a mobile electronic device; and
a second provider user interface executed by the mobile electronic device;
wherein:
the first provider backend receives a request for an enablement token to link a product provided by the first provider with a second provider from the first provider user interface and from a customer;
the first provider backend generates the enablement token;
the first provider backend sends the enablement token to the first provider user interface;
the first provider user interface provides the enablement token to the second user interface;
the first provider backend receives the enablement token and a customer identifier for the customer with the second provider from the second provider;
the first provider backend validates the enablement token; and
the first provider backend sends an authorization code and a product identifier for the product to the second provider.

11. The system of claim 10, wherein the first provider backend comprises a first provider API gateway.

12. The system of claim 10, wherein the first provider user interface comprises a browser tab for the first provider, and the second user interface comprises a browser tab for the second provider.

13. The system of claim 10, wherein the product comprises an electronic wallet.

14. The system of claim 10, wherein the enablement token comprises an alphanumeric string.

15. The system of claim 10, wherein the enablement token comprises a token expiration field.

16. The system of claim 10, wherein the enablement token comprises a state.

17. The system of claim 16, wherein the state is one of issued, consumed, and terminated.

18. The system of claim 10, wherein the customer identifier uniquely identifies the customer.

19. The system of claim 10, wherein the API gateway receives a client secret from the second provider, and the API gateway validates the client secret before validating the enablement token.
